(19) United States
(12) Patent Application Publication
(10) Pub. No.: US 2007/0243453 A1
(43) Pub. Date: Oct. 18, 2007

(54) Membrane-electrode assembly for mixed reactant fuel cell and mixed reactant fuel cell system comprising same

(76) Inventors: Chan Kwak, Suwon-si (KR); Hee-Tak Kim, Suwon-si (KR); Alexey Alexandrovichserov, Suwon-si (KR); Si-Hyun Lee, Suwon-si (KR)

Correspondence Address: Robert E. Bushnell, Suite 300, 1522 K Street, N.W., Washington, DC, 20005, US

(21) Appl. No.: 11/783,388

(22) Filed: Apr. 9, 2007

(30) Foreign Application Priority Data
Apr. 17, 2006 (KR) 10-2006-0034499

(51) Int. Cl. H01M 4/96; H01M 4/90; H01M 8/10

(52) U.S. Cl. 429/44; 429/33

(57) ABSTRACT

A membrane-electrode assembly for a mixed reactant fuel cell and a mixed reactant fuel cell system including the same. The membrane-electrode assembly includes an anode, a cathode, a polymer electrolyte membrane sandwiched between the anode and the cathode, and a conductive substrate positioned at least one outer surface of the anode and the cathode. The membrane-electrode is porous, and at least one of the anode and the cathode includes a carbon-based material network and a catalyst.

### CROSS-REFERENCE TO RELATED APPLICATION AND CLAIM OF PRIORITY

This application claims priority to and the benefit of Korean Patent Application No. 10-2006-0034499 filed in the Korean Intellectual Property Office on Apr. 17, 2006, the entire content of which is incorporated herein by reference.

### FIELD OF THE INVENTION

The present invention relates to a membrane-electrode assembly for a mixed reactant fuel cell and a mixed reactant fuel cell system including the same. More particularly, the present invention relates to a membrane-electrode assembly for a mixed reactant fuel cell that can improve the fuel cell performance due to smooth diffusion of a fuel and an oxidant into an electrode, and a mixed reactant fuel cell system including the same.

### BACKGROUND OF THE INVENTION

A fuel cell is a power generation system for producing electrical energy through an electrochemical redox reaction of an oxidant and hydrogen gas or hydrogen in a hydrocarbon-based material such as methanol, ethanol, or natural gas.

Representative exemplary fuel cells include a polymer electrolyte membrane fuel cell (PEMFC) and a direct oxidation fuel cell (DOFC). The direct oxidation fuel cell includes a direct methanol fuel cell that uses methanol as a fuel.

The polymer electrolyte fuel cell has advantages of high energy density, but it has problems because hydrogen gas is difficult to handle, and accessory facilities such as a fuel reforming processor for reforming methane or methanol, natural gas, and the like is required in order to produce hydrogen as the fuel gas.

On the contrary, a direct oxidation fuel cell has a lower energy density than that of the polymer electrolyte fuel cell, but it has the advantages of easy handling of a fuel, being capable of operating at a room temperature due to its low operation temperature, and no need of additional fuel reforming processors.

In the above fuel cell, the stack that generates electricity includes several to scores of unit cells stacked in multi-layers, and each unit cell is formed of a membrane-electrode assembly (MEA) and a separator (also referred to as a bipolar plate). The membrane-electrode assembly has an anode (also referred to as a fuel electrode or an oxidation electrode) and a cathode (also referred to as an air electrode or a reduction electrode) attached to each other with a polymer electrolyte membrane between them. The polymer electrolyte membrane includes a proton conductive polymer.

A fuel is supplied to an anode and absorbed in a catalyst thereof, and the fuel is oxidized to produce protons and electrons. The electrons are transferred into a cathode via an external circuit, and the protons are transferred to the cathode through a polymer electrolyte membrane. An oxidant is supplied to the cathode, and the oxidant, protons, and electrons are reacted on a catalyst at the cathode to produce electricity along with water.

### SUMMARY OF THE INVENTION

One embodiment of the present invention provides a membrane-electrode assembly for a mixed reactant fuel cell that can improve the fuel cell performance due to smooth diffusion of a fuel and an oxidant into an electrode.

Another embodiment of the present invention provides a mixed reactant fuel cell system including the membrane-electrode assembly.

According to an embodiment of the present invention, a membrane-electrode assembly includes a pair of electrodes comprising an anode and a cathode, at least one of the electrodes comprising a network formed by carbon-based material and a catalyst, a polymer electrolyte membrane sandwiched between the anode and the cathode, and a porous conductive substrate positioned at at least one outer surface of the anode and the cathode. The anode, the cathode, the polymer electrolyte membrane, and the conductive substrate may be all porous.

According to another embodiment of the present invention, a membrane-electrode assembly for a mixed reactant fuel cell, comprises: a pair of porous electrodes comprising an anode having a catalyst selectively catalyzing an oxidation reaction of a fuel and a cathode having a catalyst selectively catalyzing a reduction reaction of an oxidant, at least one of the cathode and the anode comprising a network formed by carbon-based material and a catalyst, the carbon-based material selected from the group consisting of carbon fiber, vapor-grown carbon fiber, carbon nanotubes, carbon nanowire, and a combination thereof; a porous polymer electrolyte membrane sandwiched between the anode and the cathode; and a porous conductive substrate positioned at at least one outer surface of the anode and the cathode.

The present invention further provides a mixed reactant fuel cell including the membrane-electrode assembly, a fuel supplier that supplies a fuel to the membrane-electrode assembly, and an oxidant supplier that supplies an oxidant to the membrane-electrode assembly.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a schematic cross-sectional view showing a stack including the membrane-electrode assemblies for a mixed reactant fuel cell according to one embodiment of the present invention;

FIG. 2 is a schematic perspective view showing a stack including the membrane-electrode assemblies for a mixed reactant fuel cell according to another embodiment of the present invention; and

FIG. 3 is a schematic view showing a mixed reactant fuel cell system according to another embodiment of the present.

### DETAILED DESCRIPTION OF THE INVENTION

An embodiment of the present invention will hereinafter be described in detail with reference to the accompanying drawings.

A fuel cell is a power generation system producing an electrical energy from an oxidation reaction of hydrocarbon based fuel such as methanol, ethanol, and natural gas and a reduction reaction of an oxidant. It generally includes a fuel supplier, a stack, and an oxidant supplier.

The membrane-electrode assembly is a part that generates electrical energy using a fuel and an oxidant from a fuel supplier and an oxidant supplier, respectively. The membrane-electrode assembly includes an anode, a cathode, and a polymer electrolyte membrane that is interposed between the anode and the cathode, and transfers protons that are generated on the anode to the cathode.

In the general fuel cell system, a stack is generally composed of several to scores of unit cells stacked in multi-layers, and each unit cell is formed of a membrane-electrode assembly with a separator. The separator plays roles to supply the fuel and the oxidant to the anode and the cathode for the reaction in the fuel cell, and to physically separate the membrane-electrode assemblies. In the general fuel cell system, the fuel is injected into the anode, and the oxidant is injected into the cathode. Since the performance of fuel cells deteriorates in the case that the fuel supplied to the cathode and/or the oxidant is supplied to the anode, the separator is required to prevent inflow of the fuel and the anode into the opposite electrodes.

Unlike the general fuel cell system, a mixed reactant fuel cell includes one catalyst that selectively catalyzes the oxidation reaction of the fuel in the anode and another catalyst that selectively catalyzes the reduction reaction of the oxidant in the cathode. Thereby, when the mixture of the fuel and the oxidant is injected into the anode and the cathode, only an oxidation reaction of the fuel is carried out in the anode and only a reduction reaction of the oxidant is carried out in the cathode. Accordingly, the mixed reactant fuel cell of an embodiment of the present invention can omit the separator required in the conventional fuel cell so that the cost of production of the fuel cell is remarkably decreased, and the size of the fuel cell can be reduced.

Since, unlike the general fuel cell system, the separator is omitted in the mixed reactant fuel cell system, a new protocol for supplying the fuel and the oxidant is needed for the mixed reactant fuel cell.

According to an embodiment of the present invention, since the membrane-electrode assembly is porous, the fuel and the oxidant can be supplied to the whole area of the membrane-electrode assembly via the pores of the membrane electrode assembly wherever the fuel and the oxidant are injected. Further, as the anode and the cathode include carbon-based materials, the porosity of electrodes is increased to facilitate the diffusion of the fuel and the oxidant in electrodes. Thereby, the fuel cell according to the present invention is improved in terms of cell efficiency.

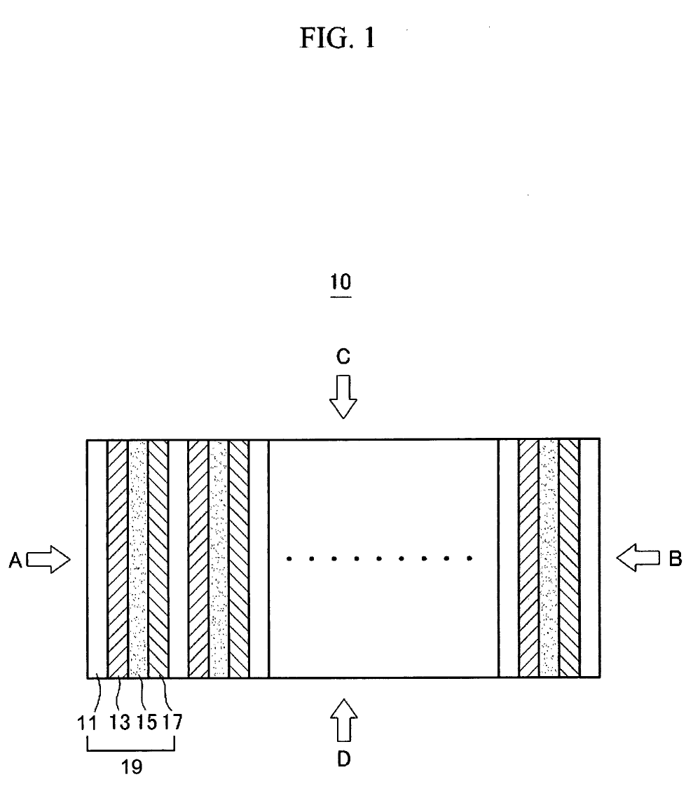

FIG. 1 is a schematic cross-sectional view showing the stack including the membrane-electrode assemblies for the mixed reactant fuel cell according to one embodiment of the present invention.

As shown in FIG. 1, the stack 10 includes at least one membrane-electrode assembly 1 that includes an anode 13, a cathode 17, a polymer electrolyte membrane 15 sandwiched between the anode 13 and the cathode 17, and a conductive substrate 11 positioned on at least one outer surface of the anode 13 and the cathode 17. The anode 13, the cathode 17, the polymer electrolyte membrane 15, and the conductive substrate 11 are porous. At least one of the anode 13 and the cathode 17 includes a carbon-based material network and a catalyst. The catalyst in pores formed by the carbon-based material network.

The polymer electrolyte membrane 15 plays a role as an ion-exchanger that transfers protons generated on the anode to the cathode, which are porous.

The polymer electrolyte membrane 15 may include any proton conductive polymer resin that is generally used in a polymer electrolyte membrane for a fuel cell. The proton conductive polymer resin includes a cation exchange group selected from the group consisting of a sulfonic acid group, a carboxylic acid group, a phosphoric acid group, a phosphonic acid group, and derivatives thereof, at its side chain.

Non-limiting examples of the proton conductive polymer resin include at least one of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In a preferred embodiment, the proton conductive polymer resin is at least one of poly(perfluorosulfonic acid) (commercially available as NAFION), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

The H can be replaced with Na, K, Li, Cs, or tetrabutylammonium in a proton conductive group of the proton conductive polymer. When the H is replaced with Na in an ion exchange group at the terminal end of the proton conductive group, NaOH can be used. When the H is replaced with tetrabutyl ammonium, tetrabutyl ammonium hydroxide can be used. K, Li, or Cs can also be replaced with appropriate compounds. A method of replacing H is known in the related art, and therefore is not described in detail.

The thickness of the polymer electrolyte membrane 15 is not specifically limited, but it may be between 10 and 200 μm. The crossover of the fuel from one electrode to the other electrode does not cause problems in the mixed reactant fuel cell, but the thickness of the polymer electrolyte membrane is preferably between 10 and 100 μm in order to increase the proton conductivity.

The surfaces of the polymer electrolyte membrane 15 are provided with the anode 13 and the cathode 17, which are porous.

At least one of the anode 13 and the cathode 17 includes a carbon-based material network and a catalyst.

The catalyst catalyzes the related reaction (oxidation of the fuel or reduction of the oxidant). The catalyst of the anode 13 is preferably selected to selectively catalyze the oxidation reaction of the fuel in the anode 13. Specifically, a platinum-ruthenium alloy catalyst may be suitably used, but the present invention is not limited thereto.

The cathode 17 may include any catalyst having selectivity for an oxidant reduction reaction. Specifically, the catalyst of the cathode 17 is selected from the group consisting of Fe-tetraphenylporphyrin (Fe-TPP), Co-tetraphenylporphyrin, (Co-TPP), Fe-tetramethoxyphenyl porphyrin (Fe-TMPP), Co-tetramethoxyphenylporphyrin (Co-TMPP), Fe-phthalocyanine (Fe-PC), Co-phthalocyanine (Co-PC), Ru—S, Ru—Se, Ru—Mo—S, Ru—Mo—Se, Ru—W—S, Ru—W—Se, and a combination thereof, which has high catalytic activity and selectivity for an oxidant reduction reaction.

The catalyst selected from Fe-tetraphenylporphyrin (Fe-TPP), Co-tetraphenylporphyrin, (Co-TPP), Fe-tetramethoxyphenyl porphyrin (Fe-TMPP), Co-tetramethoxyphenylporphyrin (Co-TMPP), Fe-phthalocyanine (Fe-PC), or Co-phthalocyanine (Co-PC) can be subjected to heat-treatment to obtain better catalytic activity.

Catalysts included in the anode 13 and the cathode 17 may be used in a form of a metal itself (black catalyst), or can be used while being supported on a support. The support may include a carbon-based material such as acetylene black, denka black, activated carbon, ketjen black, and graphite, or an inorganic particulate such as alumina, silica, zirconia, and titania. The carbon-based material is generally used in the art.

The carbon-based materials are dispersed to form a scaffold, namely a network, in the electrodes 13 and 17. In this way, the carbon-based material is networked to provide pores within the network such that the porosity of the electrodes 13 and 17 is increased.

The carbon-based material may be selected from the group consisting of carbon fibers, vapor-grown carbon fibers, carbon nanotubes, carbon nanowire, and combinations thereof. According to one embodiment, carbon fibers or vapor-grown carbon fibers may be preferably used.

The amount of the carbon-based material is preferably 1 to 10 wt % based on the total weight of the electrode, and more preferably 2 to 5 wt %. When the amount of the carbon-based material is more than 10 wt %, the catalyst is insufficient in the electrode such that the activity of the electrode is decreased. When it is less than 1 wt %, the porosity and the pore size are excessively decreased to inhibit the diffusion of the fuel and the oxidant.

The electrodes 13 and 17 may further include a binder resin to improve adherence between the electrodes 13 and 17 and a polymer electrolyte membrane 15, as well as proton transport.

The binder resin may be proton conductive polymer resin having a cation exchange group selected from the group consisting of a sulfonic acid group, a carboxylic acid group, a phosphoric acid group, a phosphonic acid group, and derivatives thereof, at its side chain. Non-limiting examples of the proton conductive polymer resin for the binder resin include at least one of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, and polyphenylquinoxaline-based polymers. In a preferred embodiment, the proton conductive polymer resin is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly (2,5-benzimidazole), and a combination thereof.

The binder resin may be used in a singularly or as a mixture. Optionally, the binder resin may be used along with a non-conductive polymer to improve adherence between the polymer electrolyte membrane and the catalyst. The amount of the binder resin may be adjusted to its usage purpose.

Non-limiting examples of the non-conductive polymer include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE)), ethylenechlorotrifluoro-ethylene copolymers (ECTFE), polyvinylidene fluoride, polyvinylidene fluoride-hexafluoropropylene copolymers (PVdF-HFP), dodecyl benzene sulfonic acid, sorbitol, and combinations thereof.

The porous membrane-electrode assembly 19 having the above-mentioned structure has a porous conductive substrate 11 on at least one of its surfaces.

The conductive substrate 11 plays a role to support the electrodes 13 and 17 to diffuse the fuel and the oxidant into the electrodes, and is porous. Thereby, the fuel and the oxidant are easily transferred to the electrodes.

In one embodiment, the conductive substrate 11 is formed from a material such as carbon paper, carbon cloth, carbon felt, or a metal cloth (a porous film composed of metal fiber or a metal film disposed on a surface of a cloth composed of polymer fibers). The conductive substrate 11 is not limited thereto.

The membrane-electrode assembly 1 may further include a microporous layer (MPL, not shown) between the conductive substrate 11 and the electrodes 13 and 17 to increase reactant diffusion effects. The microporous layer generally includes conductive powders with a certain particle diameter. The conductive material may include, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the conductive substrate. The binder resin may include, but is not limited to, polytetrafluoro ethylene, polyvinylidene fluoride, polyhexafluoro ethylene, polyperfluoroalkylvinyl ether, polyperfluoro sulfonylfluoride alkoxy vinyl ether, polyvinyl alcohol, cellulose acetate, and copolymers thereof. The solvent may include, but is not limited to, an alcohol such as ethanol, isopropyl alcohol, n-propyl alcohol, butanol, and so on, water, dimethyl acetamide, dimethyl sulfoxide, N-methylpyrrolidone, tetrahydrofuran, and so on. The coating method may include, but is not limited to, screen printing, spray coating, doctor blade methods, gravure coating, dip coating, silk screening, painting, and so on, depending on the viscosity of the composition.

When the fuel and the oxidant are injected into the membrane-electrode assembly 1 having the above-mentioned structure, the fuel and the oxidant are diffused into the whole area of the membrane-electrode assembly via the porous polymer electrolyte membrane 15, the anode 13, the cathode 17, and the conductive substrate 11. Although both the fuel and the oxidant are injected into the anode 13 and the cathode 17, the oxidation reaction of the fuel occurs only in the anode 13 as the anode 13 includes a catalyst having selectivity for the oxidation reaction of the fuel; and the reduction reaction of the oxidant occurs only in the cathode 17 as the cathode 17 includes a catalyst having selectivity for the reduction reaction of the oxidant. Protons generated from the oxidation reaction of the fuel are transferred from the anode 13 to the cathode 17 via the polymer electrolyte membrane 15, and are reacted with the oxidant and electrons provided from the anode 13 of the adjacent membrane-electrode assembly 19. Thereby water is generated and electrical energy is produced.

According to the membrane-electrode assembly 1 for a mixed reactant fuel cell of an embodiment of the present invention, as the membrane-electrode assembly is porous, the fuel and the oxidant can be diffused into the whole area of the membrane-electrode assembly regardless of the direction fuel and oxidant injection. Therefore, the direction of injecting the fuel and the oxidant is not limited. For example, the fuel and the oxidant may be injected in any direction. For example, the injection direction of the fuel and the oxidant may include, but not limited to, A direction, B direction, C direction, D direction as shown in FIG. 1, and any tilted direction.

The membrane-electrode assembly 19 for a mixed reactant fuel cell according to an embodiment of the present invention may further include a reactant supply path penetrating the membrane-electrode assembly 19 in order to facilitate the supply of the fuel and the oxidant.

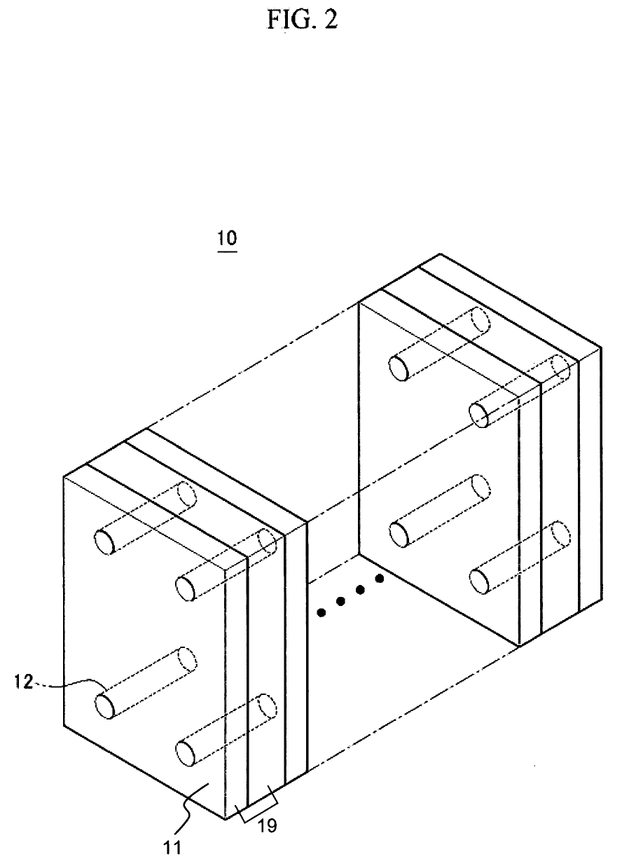

FIG. 2 is a schematic perspective view showing the stack 10 including the membrane-electrode assembly 19 for a mixed reactant fuel cell according to another embodiment of the present invention. The fuel and the oxidant are introduced into the membrane-electrode assembly 19 through a reactant supplier path 12 and diffused into whole area of the membrane-electrode assembly 19 via pores of the membrane-electrode assembly 19. Thereby, the fuel and the oxidant are efficiently supplied.

As mentioned above, since the supplying directions of the fuel and the oxidant are not limited, the direction of the reactant supplier path 12 is not limited. Further, a fuel supplier path and an oxidant supplier path are separately provided to provide the fuel and the oxidant, respectively.

The present invention further provides a mixed reactant fuel cell system, which includes the membrane-electrode assembly according to the present invention, a fuel supplier, and an oxidant supplier.

The fuel supplier plays a role of supplying the membrane-electrode assembly with a fuel, and the oxidant supplier plays a role of supplying the membrane-electrode assembly with an oxidant. The fuel includes liquid or gaseous hydrogen, or a hydrocarbon-based fuel such as methanol, ethanol, propanol, butanol, or natural gas. The oxidant generally includes oxygen. The fuel and the oxidant are not limited thereto.

The mixed reactant fuel cell system may be applied to a polymer electrolyte fuel cell (PEMFC) or a direct oxidation fuel cell (DOFC). In particular, it can be more effectively used for a direct oxidation fuel cell and most effectively for a direct methanol fuel cell (DMFC).

According to the mixed reactant fuel cell system of an embodiment of the present invention, the fuel and the oxidant may be mixed to be provided to the membrane-electrode assembly, or each of them may be provided to a different area in the membrane-electrode assembly. As the components of the polymer electrolyte membrane are porous, the fuel and the oxidant can be diffused into the whole area of the membrane-electrode assembly regardless of the way they are supplied. When the fuel and the oxidant are mixed and provided to the membrane-electrode assembly, the mixed reactant fuel cell system according to an embodiment of the present invention may further include a reactant mixing part that mixes the fuel provided from the fuel supplier with the oxidant provided from the oxidant supplier and supplies the membrane-electrode assembly therewith.

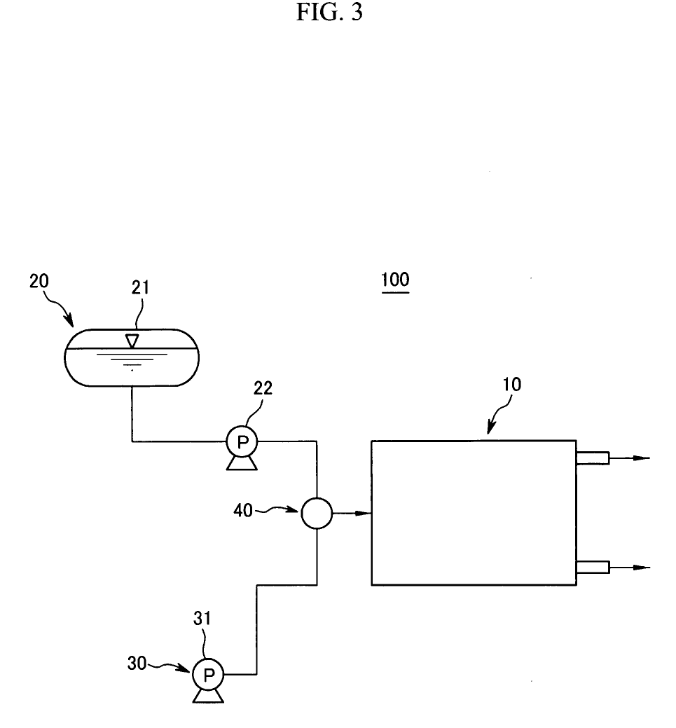

FIG. 3 is a schematic view showing a mixed reactant fuel cell system 100 according to one embodiment of the present invention, which will be described in detail with reference to this accompanying drawing as follows. FIG. 3 illustrates a fuel cell system wherein a fuel and an oxidant are provided to the stack 10 through pumps 22 and 31, but the present invention is not limited to such structures. The fuel cell system of the present invention alternatively includes a structure wherein a fuel and an oxidant are provided in a diffusion manner even without a pump.

The mixed reactant fuel cell system includes a stack 10, a fuel supplier 20 for providing the stack 10 with a fuel, and an oxidant supplier 30 for providing the stack 10 with an oxidant.

In addition, the fuel supplier 20 is equipped with a tank 21 that stores fuel and a fuel pump 22 that is connected therewith. The fuel pump 22 supplies fuel stored in the tank 21 with a predetermined pumping power.

The oxidant supplier 30, which supplies the stack 10 with an oxidant, is equipped with at least one oxidant pump 31 for supplying an oxidant with a predetermined pumping power.

The fuel cell system of an embodiment of the present invention may further include a reactant mixing part 40, which mixes the oxidant supplied from the oxidant supplier 30 with the fuel supplied from the fuel supplier 20 to inject them into the stack 10.

The fuel and the oxidant injected into the stack 10 are diffused to the whole area of the stack 10 to manifest the oxidation reaction of the fuel in the anode 13 and the reduction reaction of the oxidant in the cathode 17 to generate the electrical energy.

The following examples illustrate the present invention in more detail. However, it is understood that the present invention is not limited by these examples.

### EXAMPLE 1

0.34 g of carbon-supported Fe-tetraphenylporphyrin (Fe-TPP) was heat-treated under an argon gas atmosphere at a temperature of 750□ for 4 hours, and mixed with 2.08 g of a 5 wt % polyperfluorosulfonate binder, 0.03 g of a vapor-grown carbon fiber, and 7.4 ml of a mixed solvent of isopropyl alcohol and water (mixing ratio of 9:1) to provide a catalyst slurry for a cathode.

The catalyst slurry for the cathode was coated on a carbon paper conductive substrate and dried to provide a cathode on the conductive substrate.

0.34 g platinum-ruthenium black was mixed with 2.08 g of a polyperfluorosulfonate binder, 0.03 g of a vapor-grown carbon fiber, and 7.4 ml of a mixed solvent of isopropyl alcohol and water (mixing ratio of 9:1) to provide a catalyst slurry for the anode. The provided catalyst slurry for the anode was coated on a separate conductive substrate and dried to provide an anode.

The conductive substrates provided with the cathode and the anode were positioned on respective surfaces of a porous perfluorosulfonic acid polymer electrolyte membrane and hot-pressed at 125□ under a pressure of 200 kgf/cm² for 3 minutes to provide a single cell.

### COMPARATIVE EXAMPLE 1

A single cell was fabricated in the same manner as in Example 1, except that the vapor-grown carbon fiber was not added during preparation of the catalyst slurry for the cathode.

The provided single cells from Example 1 and Comparative Example 1 were measured to determine power density. 1 mol/L of a methanol solution and air mixture was injected into the cathode, and the product from the cathode was injected to the anode. Then, the activity was measured under the condition that the mixed reactants were supplied.

The results show that the single cell according to Example 1 to which the carbon fiber was added during the preparation of the electrode had a superior power density to that of Comparative Example 1.

The membrane-electrode assembly according to one embodiment of the present invention can improve performance of a mixed reactant fuel cell due to smooth diffusion of a fuel and an oxidant into an electrode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A membrane-electrode assembly for a mixed reactant fuel cell, comprising:
a pair of electrodes comprising an anode and a cathode, at least one of the electrodes comprising a network formed by carbon-based material and a catalyst;
a polymer electrolyte membrane sandwiched between the anode and the cathode; and
a porous conductive substrate positioned at at least one outer surface of the anode and the cathode.

2. The membrane-electrode assembly of claim 1, wherein the carbon-based material is selected from the group consisting of carbon fiber, vapor-grown carbon fiber, carbon nanotubes, carbon nanowire, and a combination thereof.

3. The membrane-electrode assembly of claim 1, wherein the carbon-based material is carbon fiber or vapor-grown carbon fiber.

4. The membrane-electrode assembly of claim 1, wherein the carbon-based material is present at 1 to 10 wt % based on the total weight of said at least one of the electrodes comprising the network.

5. The membrane-electrode assembly of claim 1, wherein the carbon-based material is present at 2 to 5 wt % based on the total weight of said at least one of the electrodes comprising a network.

6. The membrane-electrode assembly of claim 1, wherein the anode comprises a platinum-ruthenium alloy catalyst.

7. The membrane-electrode assembly of claim 1, wherein the cathode comprises a catalyst selected from the group consisting of Fe-tetraphenylporphyrin (Fe-TPP), Co-tetraphenylporphyrin (Co-TPP), Fe-tetramethoxyphenyl porphyrin (Fe-TMPP), Co-tetramethoxyphenylporphyrin (Co-TMPP), Fe-phthalocyanine (Fe-PC), Co-phthalocyanine (Co-PC), Ru—S, Ru—Se, Ru—Mo—S, Ru—Mo—Se, Ru—W—S, Ru—W—Se, and combinations thereof.

8. The membrane-electrode assembly of claim 7, wherein the catalyst selected from the group consisting of Fe-tetraphenylporphyrin (Fe-TPP), Co-tetraphenylporphyrin, (Co-TPP), Fe-tetramethoxyphenyl porphyrin (Fe-TMPP), Co-tetramethoxyphenylporphyrin (Co-TMPP), Fe-phthalocyanine (Fe-PC), and Co-phthalocyanine (Co-PC) is heat-treated.

9. The membrane-electrode assembly of claim 1, wherein the polymer electrolyte membrane comprises a proton conductive polymer resin having a cation exchange group selected from the group consisting of a sulfonic acid group, a carboxylic acid group, a phosphoric acid group, a phosphonic acid group, and derivatives thereof, at its side chain.

10. The membrane-electrode assembly of claim 9, wherein the polymer electrolyte membrane comprises at least one polymer resin selected from the group consisting of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

11. The membrane-electrode assembly of claim 10, wherein the polymer electrolyte membrane comprises at least one polymer resin selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly (2,5-benzimidazole), and combinations thereof.

12. The membrane-electrode assembly of claim 1, wherein the conductive substrate is selected from the group consisting of carbon paper, carbon cloth, carbon felt, metal cloth, and combinations thereof.

13. The membrane-electrode assembly of claim 1, wherein the membrane-electrode assembly has a reactant supply path penetrating the membrane-electrode assembly.

14. A membrane-electrode assembly for a mixed reactant fuel cell, comprising:
a pair of porous electrodes comprising an anode having a catalyst selectively catalyzing an oxidation reaction of a fuel and a cathode having a catalyst selectively catalyzing a reduction reaction of an oxidant, at least one of the cathode and the anode comprising a network formed by carbon-based material and a catalyst, the carbon-based material selected from the group consisting of carbon fiber, vapor-grown carbon fiber, carbon nanotubes, carbon nanowire, and a combination thereof;
a porous polymer electrolyte membrane sandwiched between the anode and the cathode; and
a porous conductive substrate positioned at at least one outer surface of the anode and the cathode.

15. The membrane-electrode assembly of claim 14, wherein the membrane-electrode assembly has a reactant supply path penetrating the membrane-electrode assembly.

16. A mixed reactant fuel cell system, comprising:
a membrane-electrode assembly comprising
a pair of electrodes comprising an anode and a cathode, at least one of the electrodes comprising a network formed by carbon-based material and a catalyst;
a polymer electrolyte membrane sandwiched between the anode and the cathode; and
a porous conductive substrate positioned at at least one outer surface of the anode and the cathode;
a fuel supplier supplying a fuel to the membrane-electrode assembly, and
an oxidant supplier supplying an oxidant to the membrane-electrode assembly.

17. The mixed reactant fuel cell system of claim 16, further comprising a reactant mixing part mixing the fuel supplied from the fuel supplier and the oxidant supplied from the oxidant supplier to supply the mixed fuel and oxidant to the membrane-electrode assembly.

18. The mixed reactant fuel cell system of claim 16, which is a direct oxidation fuel cell system.

19. The mixed reactant fuel cell system of claim 18, which is a direct methanol fuel cell system.
